(19) United States
(12) Patent Application Publication
(10) Pub. No.: US 2017/0218915 A1
(43) Pub. Date: Aug. 3, 2017

(54) Lifting Device for a Wind Turbine Rotor Blade

(71) Applicant: General Electric Company, Schenectady, NY (US)

(72) Inventors: Theodore Steven Wilmot, Laurens, SC (US); Bruce Clark Busbey, Greenville, SC (US); Ryan Spencer Close, Greenville, SC (US)

(21) Appl. No.: 15/011,725

(22) Filed: Feb. 1, 2016

(51) Int. Cl. F03D 1/00; B66C 23/18; B66C 1/10; F03D 1/06; F03D 13/20

(52) U.S. Cl. CPC F03D 1/001; F03D 1/0675; F03D 1/0691; F03D 13/20; B66C 1/108; B66C 23/185; F05B 2230/61; F05B 2240/221

(57) ABSTRACT

The present disclosure is directed to a lifting device for a rotor blade of a wind turbine. The lifting device includes at least one cradle and a vacuum sealing system configured with the cradle. The cradle has a profile that corresponds to at least one of the exterior surfaces of the rotor blade so as to support at least a portion of the rotor blade. The vacuum sealing system is configured to secure the rotor blade to the cradle as the rotor blade is lifted and/or lowered from a hub mounted atop a tower of the wind turbine.

### FIELD OF THE INVENTION

The present disclosure relates in general to wind turbines, and more particularly to lifting devices for wind turbine rotor blades.

### BACKGROUND OF THE INVENTION

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The typical construction of a wind turbine involves erecting the tower and then connecting various other components to the erected tower. For example, the rotor blades may be lifted to an appropriate height and connected to the tower after erection of the tower. In some cases, each of the rotor blades is connected to a hub before lifting, and the connected rotor blades and hub are then lifted and connected to the tower as a unit. Trends towards taller towers and larger rotor diameters, however, can limit and/or preclude lifting such units to the tower due to size and/or cost. More specifically, as the rotor diameter and/or mass and hub height increases, there are few (if any) cranes that can lift such structures. Further, the sail area can become so large, that the available wind window to conduct such lifts approaches zero, i.e. the cranes cannot lift the rotor without tipping over.

Thus, current systems and methods for lifting the rotor blades involve the use of a cradle, sling, or clamping-type blade lifting tool that is lifted to the tower using a crane. The rotor blades are then connected to the tower, and the crane is then disconnected therefrom. To overcome safety risks, many modern lifting tools incorporate positive clamping means to prevent blade movement or loss of control during the lifting process. This approach can damage the blade airfoil structure if the lifting tool contact locations do not correspond with structurally reinforced regions of the blade (e.g. the spar cap).

Thus, one approach to prevent blade damage during lifting is to add ribs or similar structural reinforcements at the tool interface regions. However, such add-ons can increase blade mass as well as cost.

In view of the aforementioned, an improved lifting device for wind turbine rotor blades is desired in the art. For example, a lifting device that may prevent rotor blade damage during lifting and connecting of the rotor blades to an erected tower would be advantageous.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a lift system for a rotor blade of a wind turbine. The lift system includes a rotor blade and at least one lifting device. The rotor blade generally has exterior surfaces defining a pressure side, a suction side, a leading edge, and a trailing edge extending in a generally span-wise direction between a blade root and a blade tip. The lifting device includes at least one cradle and a vacuum sealing system configured with the cradle. The cradle has a profile that corresponds to at least one of the exterior surfaces of the rotor blade so as to support at least a portion thereof. The vacuum sealing system is configured to secure the rotor blade within the cradle as the rotor blade is lifted and/or lowered from a hub mounted atop a tower of the wind turbine.

In one embodiment, the lifting device may include a root cradle for supporting the root of the rotor blade and a tip cradle for supporting the tip of the rotor blade. Thus, in certain embodiments, the lifting device may include a structural frame body for connecting and supporting the root cradle and the tip cradle. More specifically, in some embodiments, the structural frame body may include a root cradle support and a tip cradle support connected via a main support. Thus, the root cradle support is configured to support the root cradle, whereas the tip cradle support is configured to support the tip cradle.

Thus, in certain embodiments, the lift system may also include a crane cable or sling coupled to a crane and the main support. In such embodiments, the crane and the crane cable/sling are configured for lifting and/or lowering the rotor blade between the hub and the ground. In another embodiment, the lift system may include one or more safety features configured to restrict movement of the rotor blade.

In another embodiment, the vacuum sealing system may further include a vacuum reservoir, a vacuum pump configured with the vacuum reservoir, one or more valves configured therebetween, and one or more pressure transmitters or sensors. Thus, in additional embodiments, the lift system may also include a controller configured to receive signals from the pressure transmitters and control the one or more valves so as to provide a vacuum between the cradle and the rotor blade.

In further embodiments, the cradle may include at least one vacuum channel configured therethrough that is in fluid communication with the vacuum reservoir. In addition, the cradle may include at least one seal configured to contact at least one of the exterior surfaces of the rotor blade. More specifically, in certain embodiments, the seal may be configured with a face of the cradle around a periphery thereof. As such, the vacuum channels may be configured within the periphery of the cradle. Thus, the vacuum sealing system is configured to create a vacuum seal between the cradle and the rotor blade via the seal.

In particular embodiments, the seal(s) may be constructed of an elastomeric material. For example, in certain embodiments, the elastomeric material may include a polyurethane, a rubber, a silicone, a latex, or any other suitable elastomeric materials or combinations thereof.

In another aspect, the present disclosure is directed to a lifting device for lifting and/or lowering a rotor blade to and from a hub mounted atop a tower of a wind turbine. The lifting device includes at least one cradle configured to support at least a portion of the rotor blade. Further, the cradle includes a profile that corresponds to at least one of the exterior surfaces of the rotor blade. The lifting device also includes a vacuum sealing system configured with the cradle so as to secure the rotor blade within the cradle as the rotor blade is being lifted and/or lowered to and from the hub, e.g. during installation and/or service work of the rotor blade. It should be understood that the lifting device may be further includes any of the additional features as described herein.

In yet another embodiment, the present disclosure is directed to a method for lifting a rotor blade to a hub mounted atop a tower of a wind turbine. The method includes installing a blade root of the rotor blade into a root cradle of a lifting device. The method also includes installing a blade tip of the rotor blade into a tip cradle of the lifting device. Another step includes securing the blade root and the blade tip of the rotor blade in the root and tip cradles, respectively, via a vacuum sealing system configured with each of the cradles. Further, the method includes securing a crane cable or sling to the lifting device and lifting, via a crane secured to the crane cable/sling, the rotor blade to the hub mounted atop the tower of the wind turbine.

In one embodiment, the method also includes receiving, via one or more sensors, a plurality of pressure signals indicative of a vacuum pressure of the vacuum sealing system, and controlling, via a controller communicatively coupled to the one or more sensors, the vacuum pressure of the vacuum sealing system so as to maintain a vacuum between the blade root and tip of the rotor blade and the root and tip cradles, respectively. It should be understood that the method may further include any of the additional steps and/or features as described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a side view of one embodiment of a rotor blade according to the present disclosure;

FIG. 3 illustrates a perspective view of one embodiment of a lift system according to the present disclosure;

FIG. 4 illustrates a perspective view of one embodiment of a lifting device according to the present disclosure;

FIG. 5 illustrates a perspective view of another embodiment of a lift system according to the present disclosure, particularly illustrating the root and tip cradles thereof;

FIG. 6 illustrates a plan view of one embodiment of the root and tip cradles of a lift system according to the present disclosure, particularly illustrating the seals and vacuum channels thereof;

FIG. 7 illustrates a schematic diagram of one embodiment of a vacuum sealing system of a lifting device for a rotor blade of a wind turbine according to the present disclosure;

FIG. 8 illustrates a perspective view of yet another embodiment of a lift system according to the present disclosure, particularly illustrating various safety features thereof; and,

FIG. 9 illustrates a flow diagram of one embodiment of a method for lifting a rotor blade to a hub mounted atop a tower of a wind turbine according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a lifting device for a wind turbine rotor blade. More specifically, the lifting device includes at least one cradle for supporting the rotor blade at one or more locations and a vacuum sealing system configured with the cradle so as to secure the rotor blade therein. For example, the cradle has a profile that corresponds to at least one of the exterior surfaces of the rotor blade so as to support at least a portion thereof. Further, the cradle includes a seal configured around a periphery thereof. Thus, the vacuum sealing system is configured to create a vacuum between the rotor blade and the cradle via the seal. Accordingly, the rotor blade remains secure within the cradle as the blade is lifted and/or lowered from a hub mounted atop a tower of the wind turbine.

The present disclosure provides many advantages not present in the prior art. For example, the lifting device of the present disclosure reduces potential blade damage due to gripping-type interfaces. Further, the lifting device of the present disclosure eliminates the need for additional blade structures (e.g. such as ribs) to lift or lower the blade, thereby preventing associated blade damage.

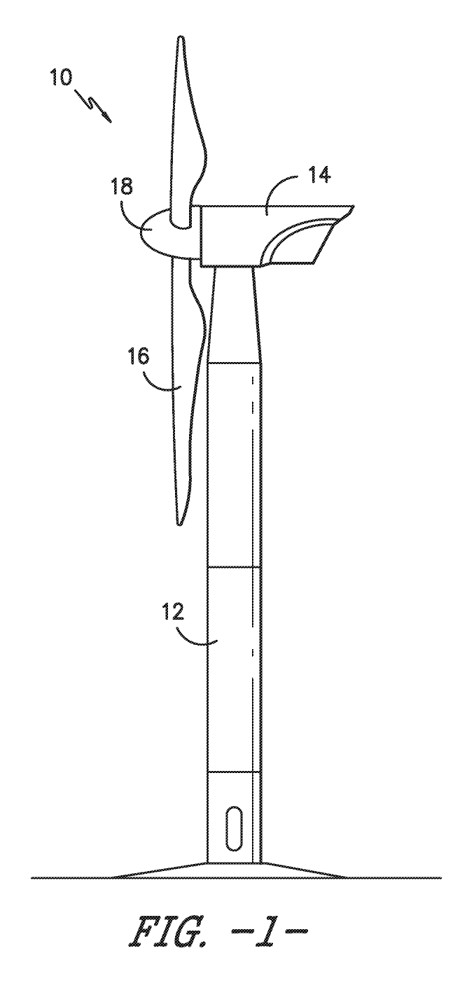

Referring now to the drawings, FIG. 1 illustrates a wind turbine 10 of conventional construction. The wind turbine 10 includes a tower 12 with a nacelle 14 mounted thereon. A plurality of rotor blades 16 are mounted to a rotor hub 18, such as via the roots (discussed below) of the rotor blades, which is in turn connected to a main flange that turns a main rotor shaft (not shown). The wind turbine power generation and control components are typically housed within the nacelle 14 and/or the tower 12. The view of FIG. 1 is provided for illustrative purposes only to place the present invention in an exemplary field of use. It should be appreciated that the invention is not limited to any particular type of wind turbine configuration.

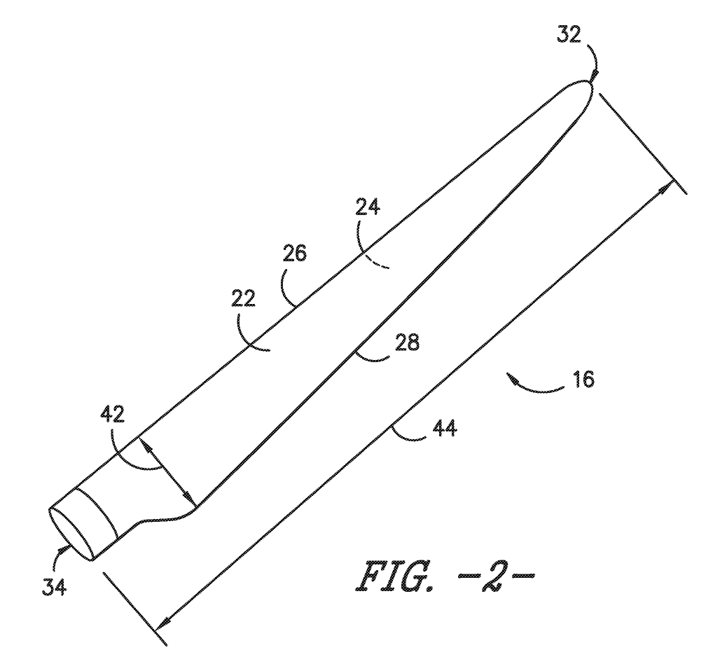

Referring to FIG. 2, a rotor blade 16 according to the present disclosure may include exterior surfaces defining a pressure side 22 and a suction side 24 extending between a leading edge 26 and a trailing edge 28, and may extend from a blade tip 32 to a blade root 34. The exterior surfaces may be generally aerodynamic surfaces having generally aerodynamic contours, as is generally known in the art. In some embodiments, the rotor blade 16 may include a plurality of individual blade segments aligned in an end-to-end order from the blade tip 32 to the blade root 34. Each of the individual blade segments may be uniquely configured such that the plurality of blade segments define a complete rotor blade 16 having a designed aerodynamic profile, length, and other desired characteristics. For example, each of the blade segments may have an aerodynamic profile that corresponds to the aerodynamic profile of adjacent blade segments. Thus, the aerodynamic profiles of the blade segments may form a continuous aerodynamic profile of the rotor blade 16. Alternatively, the rotor blade 16 may be formed as a singular, unitary blade having the designed aerodynamic profile, length, and other desired characteristics.

The rotor blade 16 may, in exemplary embodiments, be curved. Curving of the rotor blade 16 may entail bending the rotor blade 16 in a generally flap-wise direction and/or in a generally edge-wise direction. The flap-wise direction may generally be construed as the direction (or the opposite direction) in which the aerodynamic lift acts on the rotor blade 16. The edge-wise direction is generally perpendicular to the flap-wise direction. Flap-wise curvature of the rotor blade 16 is also known as pre-bend, while edgewise curvature is also known as sweep. Thus, a curved rotor blade 16 may be pre-bent and/or swept. Curving may enable the rotor blade 16 to better withstand flapwise and edgewise loads during operation of the wind turbine 10, and may further provide clearance for the rotor blade 16 from the tower 12 during operation of the wind turbine 10.

Still referring to FIG. 2, the rotor blade 16 may further define chord 42 and a span 44. Further, as shown in FIG. 2, the chord 42 may vary throughout the span 44 of the rotor blade 16. Thus, a local chord may be defined for the rotor blade 16 at any point on the rotor blade 16 along the span 44. The exterior surfaces, as discussed above, may extend in the generally span-wise direction between the tip 32 and root 34.

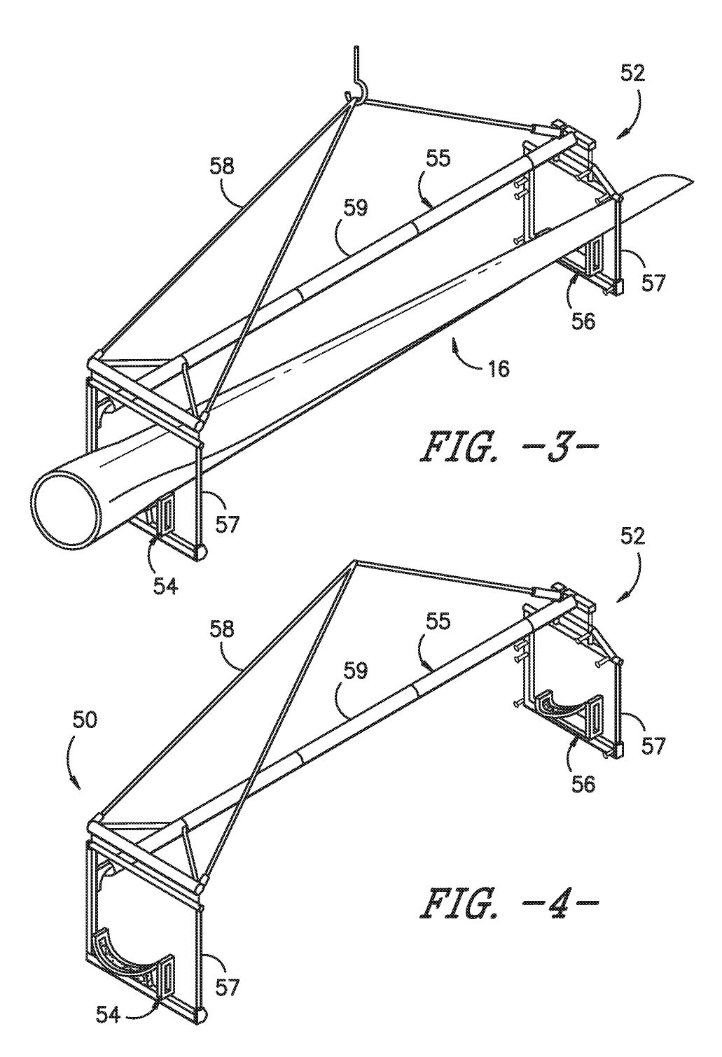

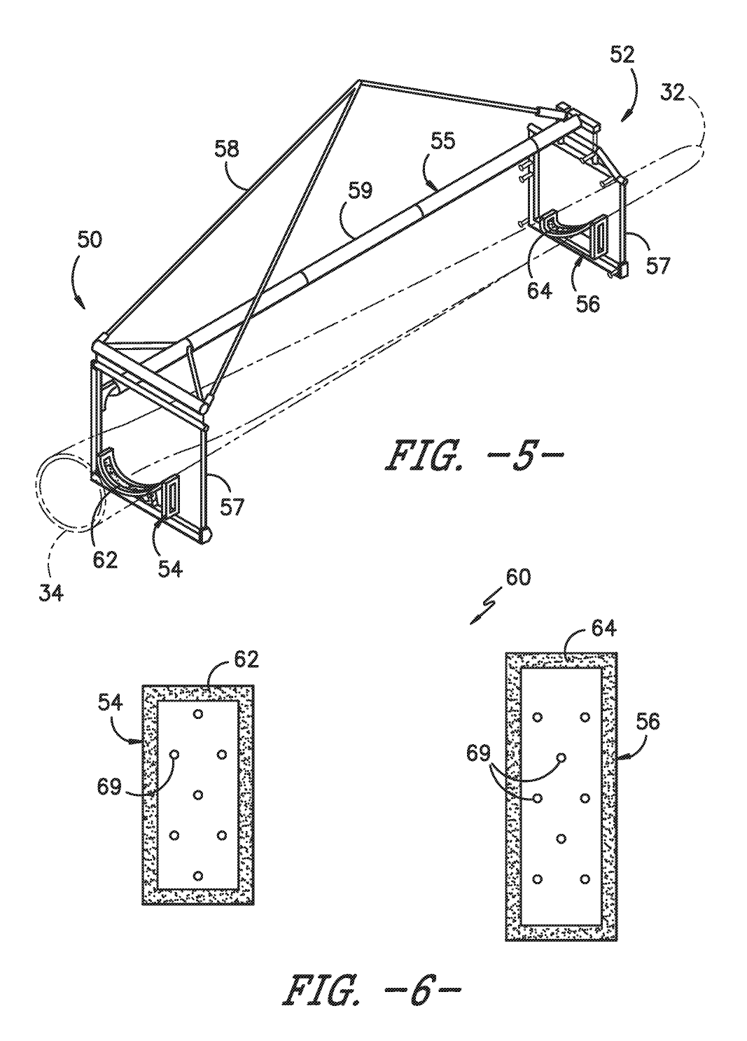

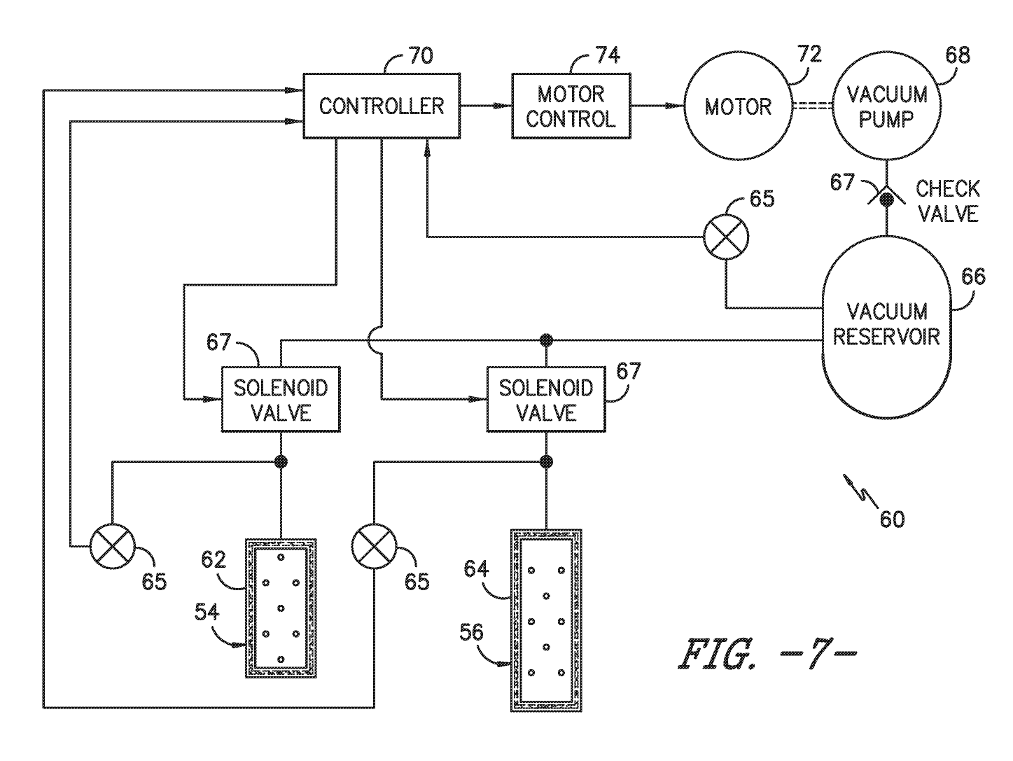

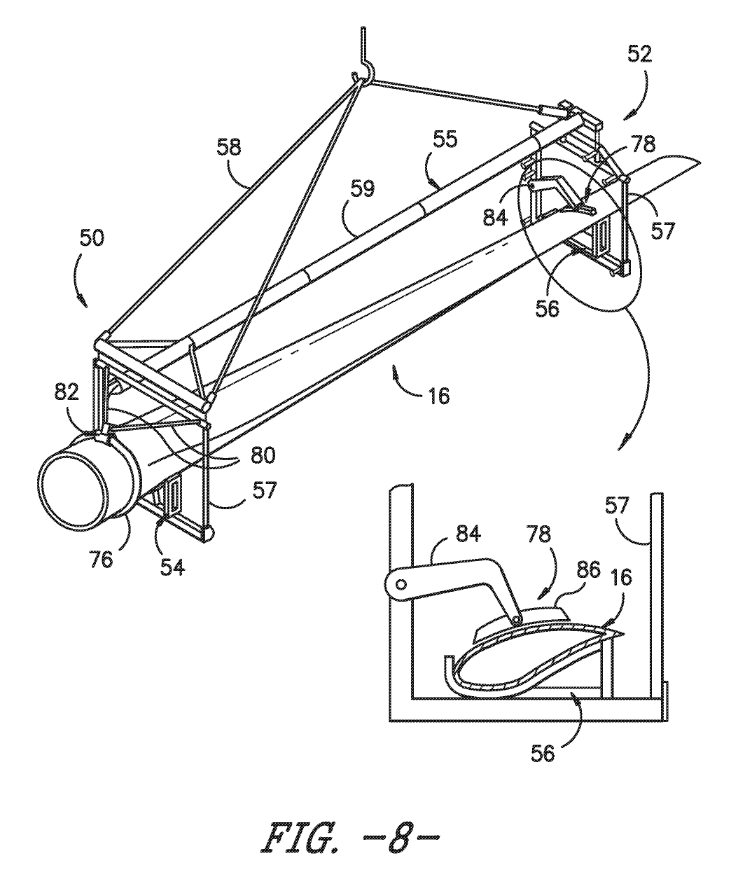

Referring now to FIGS. 3 through 7, various components of a lift system 50 for a rotor blade 16 of a wind turbine 10 according to the present disclosure are illustrated. As shown in FIGS. 3 and 4, the lift system 50 includes a lifting device 52 configured to support at least a portion of the rotor blade 16. More specifically, as shown, the lifting device 52 includes at least one cradle 54, 56 and a vacuum sealing system 60 (FIGS. 6 and 7) configured with the cradle(s) 54, 56, which is described in more detail below. For example, as shown generally in FIGS. 3-6, the lifting device 52 includes a root cradle 54 and a tip cradle 56 for supporting portions of the blade 16 near the blade root 34 and the blade tip 32, respectively. Further, in certain embodiments, each of the cradles 54, 56 generally has a profile that corresponds to at least one of the exterior surfaces of the rotor blade 16 so as to support at least a portion of the rotor blade 16. For example, as shown in FIGS. 3 and 5, the root cradle 54 has a profile that generally corresponds to the blade root 34 of the rotor blade 16, whereas the tip cradle 56 has a profile that generally corresponds to the blade tip 32 of the rotor blade 16.

In addition, as shown in FIGS. 3-5 the lifting device 52 may include a structural frame body 55 for connecting and supporting the root cradle 54 and the tip cradle 56. More specifically, as shown, the structural frame body 55 may include one or more cradle supports 57 configured to support each of the root and tip cradles 54, 56, respectively. Thus, as shown, the root and tip cradles 54, 56 may be mounted to respective ends of the structural frame body 55. Further, the cradle supports 57 may be joined or coupled together via a main support 59 or beam. Thus, in additional embodiments, the lift system 50 may also include a crane (not shown) and a crane cable or sling 58 (FIGS. 3 and 4). In such embodiments, the crane cable or sling 58 may be connected to the crane and the structural frame body 55 (i.e. at a central location along the main support 59) for lifting and/or lowering the rotor blade 16 between the hub 18 and the tower 12. More specifically, as shown, the crane cable or sling 58 may include a synthetic fabric sling and a point attachment at the center of the structural frame body 55 so as to provide stability to the lifting device 52 during lifting and/or lowering.

The crane as described herein may be any suitable machine for generally lifting equipment and/or materials, such as a mobile crane, a floating crane, an aerial crane, or a fixed crane (such as a tower crane), as is generally known in the art. Further, the crane cable or sling 58 may be connected to the crane, and the crane may control movement of the crane cable or sling 58, as is generally known in the art.

In addition, as shown in FIGS. 6 and 7, the cradles 54, 56 may also include one or more seals 62, 64 configured to contact at least one of the exterior surfaces of the rotor blade 16 when the blade 16 is installed in the lifting device 52. More specifically, as shown in FIGS. 5-7, the seals 62, 64 may be configured with a face of the cradles 54, 56 around a periphery thereof. For example, as shown particularly in FIG. 6, each of the seals 62, 64 has a substantially rectangular shape that corresponds to the substantially rectangular face of the root and tip cradles 54, 56. Further, the seals 62, 64 may be constructed of any suitable material suitable for forming a seal between the rotor blade 16 and the cradles 54, 56. Thus, in certain embodiments, the seals 62, 64 may be constructed of an elastomeric material. For example, in one embodiment, the elastomeric material may include a polyurethane, a rubber, a silicone, a latex, or any other suitable elastomeric materials or combinations thereof.

Referring now to FIGS. 6 and7, the vacuum sealing system 60 of the lifting device 52 is configured to secure the rotor blade 16 within or to the cradles 54, 56 as the rotor blade 16 is being lifted and/or lowered from the hub 18 mounted atop the tower 12 of the wind turbine 10. Thus, the vacuum sealing system 60 may include any suitable components for creating a vacuum seal between the rotor blade 16 and the cradle(s) 54, 56. For example, as shown in the illustrated embodiment, the vacuum sealing system 60 may include, at least, a controller 70 communicatively coupled to a vacuum reservoir 66, a vacuum pump 68, one or more valves 67, and one or more pressure transmitters 65 or sensors configured to transmit one or more pressure signals to the controller 70. Further, the vacuum pump 68 may include any suitable pump, e.g. having a motor 72 and/or optional motor control 74. In addition, each of the cradles 54, 56 may be equipped with one or more vacuum channels 69 in fluid communication to the vacuum reservoir 66.

Thus, in certain embodiments, the controller 70 is configured to receive pressure signals indicative of a vacuum pressure of the vacuum sealing system 60 from the pressure transmitters 65. Accordingly, the controller 70 is configured to control the vacuum pressure of the vacuum sealing system 60 via the valve(s) 67 so as to maintain a vacuum between the blade root 34 and the blade tip 32 of the rotor blade 16 and the root cradle 54 and the tip cradle 56, respectively. As such, the controller 70 provides and/or maintains a suitable vacuum pressure between the seals 62, 64 and the rotor blade 16, which secures the rotor blade 16 in the lifting device 52 during lifting without damaging the blade 16.

The controller 70 as described herein may be incorporated into a suitable control system of the wind turbine 10 (not shown), such as a handheld remote, a personal digital assistant, cellular telephone, a separate pendant controller, or a computer. Further, the controller 70 may include suitable processing apparatus and software for operating the vacuum sealing system 60 as desired or required.

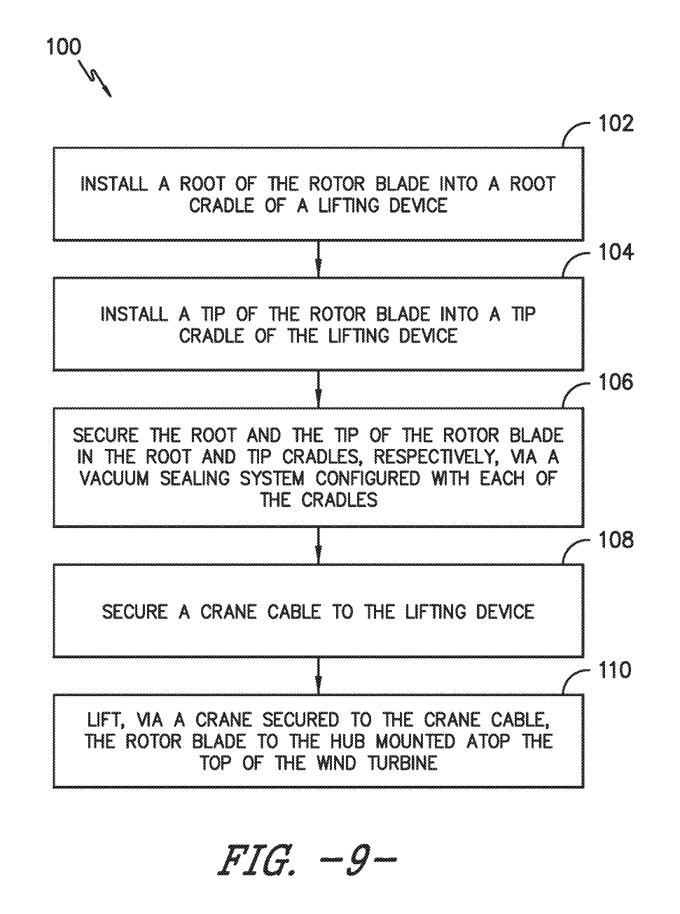

Referring now to FIG. 8, the lift system 50 may also include one or more safety features 76, 78 for use in the event that the vacuum sealing system 60 fails. For example, as shown, a first safety feature 76 configured with the root cradle 54 and a second safety feature 78 configured with the tip cradle 56. More specifically, as shown, the first safety feature 76 may include a root end choker connected to the root cradle 54 via one or more slings 80. In addition, as shown, the choker 76 may include a quick-disconnect release 82. Further, as shown, the second safety feature 78 may include a non-contact gate having an optionally pivotable arm 84 with an air-foil shaped attachment 86 at a distal end thereof. During normal operation of the vacuum sealing system 60, the airfoil-shaped attachment 86 does not contact the rotor blade 16. However, in the event that the sealing system fails 60, the airfoil-shaped attachment 86 cooperates with the root end choker 76 to prevent the rotor blade 16 from dislodging from the cradles 54, 56. More specifically, the geometry of the airfoil-shaped attachment 86 restricts movement of the blade tip 32 of the rotor blade 16, while the choker 76 restricts movement of the blade root 34.

The present disclosure is further directed to a method for lifting a rotor blade 16 to a hub 18 mounted atop a tower 12 of a wind turbine 10. For example, as shown in FIG. 9 at 102, the method 100 includes installing a blade root 34 of the rotor blade 16 into a root cradle 54 of a lifting device 52. Similarly, the root cradle 54 may be installed onto the blade root 34 of the rotor blade 16. As shown at 104, the method 100 also includes installing a blade tip 32 of the rotor blade 16 into a tip cradle 56 of the lifting device 52. Further, the tip cradle 56 may be installed onto the blade tip 32 of the rotor blade 16. As shown at 106, the method 100 securing the blade root 34 and the blade tip 32 of the rotor blade 16 in the root and tip cradles 54, 56, respectively, via a vacuum sealing system 60 configured with each of the cradles 54, 56. As shown at 108, the method 100 securing a crane cable or sling 58 to the lifting device 52. As shown at 110, the method 100 lifting, via a crane secured to the crane cable 58, the rotor blade 16 to the hub mounted atop the tower 12 of the wind turbine 10.

In one embodiment, the method 100 also includes receiving, via one or more sensors (e.g. pressure transmitters 67), a plurality of pressure signals indicative of a vacuum pressure of the vacuum sealing system 60, and controlling, via a controller 70 communicatively coupled to the one or more sensors, the vacuum pressure of the vacuum sealing system 60 so as to provide and maintain a vacuum between the blade root 34 and the blade tip 32 of the rotor blade 16 and the root cradle 54 and the tip cradle 56, respectively.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A lift system a rotor blade of a wind turbine, the lift system mprising:
a rotor blade having exterior surfaces defining a pressure side, a suction side, a leading edge, and a trailing edge extending in a generally span-wise direction between a tip and a root;
a lifting device comprising at least one cradle comprising a blade-contacting surface having a shape that corresponds to at least one of the exterior surfaces of the rotor blade so as to support at least a portion of the rotor blade the at least one cradle further comprising least one seal secured around at least a portion of a periphery of the blade-contacting surface and a vacuum channel extending through the at least one cradle to the blade-contacting surface within the seal; and,
a vacuum sealing system configured to secure the rotor blade to the seal as the rotor blade is lifted or lowered from a hub mounted atop a tower of the wind turbine.

2-3. (canceled)

4. The lift system of claim 1, wherein the at least one seal is constructed of an elastomeric material, wherein the elastomeric material comprises at least one of a polyurethane, a rubber, a silicone, or a latex.

5. The lift system of claim 1, wherein the vacuum sealing system further comprises:
a vacuum reservoir,
a vacuum pump configured with the vacuum reservoir, and
one or more valves configured therebetween.

6. The lift system of claim 5, further comprising a controller and one or more sensors, the controller configured to receive signals from the one or more sensors so as to control the one or more valves to provide a vacuum between the at least one seal and the rotor blade.

7. The lift system of claim 5, wherein the at least one vacuum channel is in fluid communication with the vacuum reservoir.

8. The lift system of claim 1, further comprising a root cradle for supporting the root of the rotor blade and a tip cradle for supporting the tip of the rotor blade.

9. The lift system of claim 8, wherein the lifting device further comprises a structural frame body for connecting and supporting the root cradle and the tip cradle.

10. The lift system of claim 1, further comprising one or more safety features configured to restrict movement of the rotor

11. The lift system of claim 10, further comprising a crane and a crane cable or sling, the crane cable or sling connected to the crane and the structural frame body for lifting or lowering the rotor blade between the hub and the ground.

12. A lifting device for lifting or lowering a rotor blade to and from a hub mounted atop a tower of a wind turbine, the lifting device comprising:
at least one cradle configured to support at least a portion of the rotor blade, the at least one cradle comprising a blade-contacting surface having a shape profile that corresponds to at least one of the exterior surfaces of the rotor blade, the at least one cradle further comprising least one seal secured around at least a portion of a periphery of the blade-contacting surface and a vacuum channel extending through the at least one cradle to the blade-contacting surface; and,
a vacuum sealing system configured with the cradle so as to secure the rotor blade to the seal as the rotor blade is lifted or lowered to and from the hub.

13-14. (canceled)

15. The lifting device of claim 12, wherein the at least one seal is constructed of an elastomeric material, wherein the elastomeric material comprises at least one of a polyurethane, a rubber, a silicone, or a latex.

16. The lifting device of claim 12, wherein the vacuum sealing system further comprises:
a vacuum reservoir,
a vacuum pump configured with the vacuum reservoir, and
one or more valves configured therebetween, wherein the at least one cradle further comprises at least one vacuum channel configured therethrough, the at least one vacuum channel in fluid communication with the vacuum reservoir.

17. The lifting device of claim 12, further comprising:
a root cradle for supporting the root of the rotor blade,
a tip cradle for supporting the tip of the rotor blade, and
a structural frame body for connecting and supporting the root cradle and the tip cradle.

18. The lifting device of claim 12, further comprises one or more safety features configured to restrict movement of the rotor blade.

19. A method for lifting a rotor blade to a hub mounted atop a tower of a wind turbine, the method comprising:
placing a root of the rotor blade atop a first seal secured around at least a portion of a periphery of a root cradle of a lifting device;
placing a tip of the rotor blade atop a second seal secured around at least a portion of a periphery of a tip cradle of the lifting device;
securing the root and the tip of the rotor blade in the root and tip cradles, respectively, via a vacuum sealing system configured with each of the cradles, the vacuum sealing system comprising at least one vacuum channel extending through each of the root and tip cradles to blade-contacting surfaces thereof within the first and second seals, respectively;
securing a crane cable or sling to the lifting device; and,
lifting, via a crane secured to the crane cable or sling, the rotor blade to the hub mounted atop the tower of the wind turbine.

20. The method of claim 19, further comprising:
receiving, via one or more sensors, a plurality of pressure signals indicative of a vacuum pressure of the vacuum sealing system, and
controlling, via a controller communicatively coupled to the one or more sensors, the vacuum pressure of the vacuum sealing system so as to maintain a vacuum between the root and the tip of the rotor blade and the root cradle and the tip cradle, respectively.
